(19) United States
(12) Patent Application Publication
(10) Pub. No.: US 2026/0349741 A1
(43) Pub. Date: Nov. 5, 2026

(54) AUTOMATIC DISCOVERY OF A PERIPHERAL DEVICE AND RECOVERY OF AN INFORMATION HANDLING SYSTEM

(71) Applicant: DELL PRODUCTS L.P., Round Rock, TX (US)

(72) Inventors: Venkata Rama Krishna Rao Atta, Hyderabad (IN); Adolfo Montero, Pflugerville, TX (US); Ibrahim Sayyed, Georgetown, TX (US); Marcin Nowak, Prosper, TX (US)

(21) Appl. No.: 19/079,171

(22) Filed: Mar. 13, 2025

(51) Int. Cl. G06F 9/4401

(52) U.S. Cl. CPC G06F 9/4401

(57) ABSTRACT

An information handling system includes system on a chip (SoC) and an embedded controller. The SoC executes boot operations in the information handling system. The boot operations are performed based on a basic input/output system (BIOS) image. The embedded controller monitors the boot operations being executed by the SoC. In response to a boot failure, the information handling system enters into a service mode. During the service mode, the information handling system retrieves a backup BIOS image from an external device connected to the information handling system.

### FIELD OF THE DISCLOSURE

The present disclosure generally relates to information handling systems, and more particularly relates to utilizing a peripheral device for recovery of an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes system on a chip (SoC) and an embedded controller. The SoC may execute boot operations in the information handling system. The boot operations are performed based on a basic input/output system (BIOS) image. The embedded controller may monitor the boot operations being executed by the SoC. In response to a boot failure, the information handling system may enter into a service mode. During the service mode, the information handling system may retrieve a backup BIOS image from an external device connected to the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of portion of a system including multiple information handling systems and a dock according to at least one embodiment of the present disclosure;

FIG. 2 is a flow diagram of a method for automatically discovering a peripheral device for recovery of an information handling system according to at least one embodiment of the present disclosure; and

FIG. 3 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

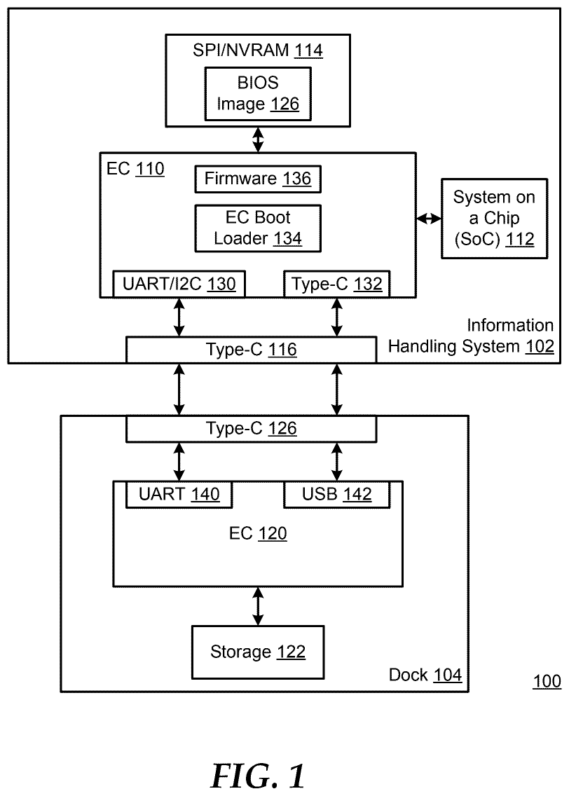

FIG. 1 illustrates a portion of a system 100 including an information handling system 102 and a dock 104 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 102 includes an embedded controller 110, a system on a chip (SoC) 112, a storage device 114, and a universal serial bus (USB) type-C connector 116. In an example, storage device 114 may be any suitable type of storage device, such as a serial peripheral interface/non-volatile random access memory (SPI/NVRAM) or the like. Dock 104 includes an embedded controller 120, a storage device 122, and a type-C connector 126. In an example, storage device 122 may be any suitable type of storage device, such as a hidden NVRAM or the like.

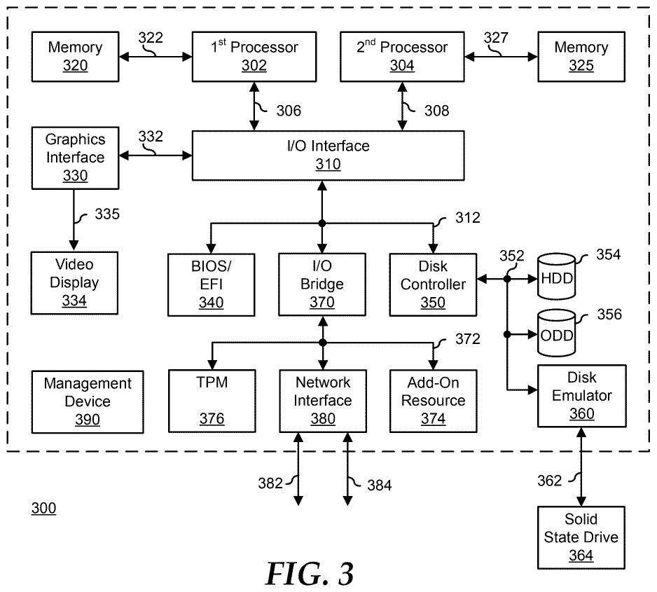

Embedded controller 110 includes universal asynchronous receiver-transmitter (UART)/inter-integrated circuit (UART/I2C) communication lanes 130, a type-C connector 132, an embedded controller boot loader 134, and firmware 136. Embedded controller 120 includes UART lanes 140 and USB lanes 142. Information handling system 102 and dock 104 may include additional components, such as the components of information handling system 300 in FIG. 3, without varying from the scope of this disclosure.

In an example, information handling system 102 may experience a no-power, no power on self-test (POST), and no-video (NP/NP/NV) situation during an attempt to power on and boot the information handling system. In this example, embedded controller boot loader 134 and embedded controller firmware 136 may detect flash corruption. This flash corruption may be both in storage 114 and backup local copies, such as firmware 136. In certain examples, the flash corruption may be based on these copies of BIOS image 126 may be broken and the corruption may cause information handling system 102 to be in a NP/NP/NV state. However, information handling system 102 may be improved by embedded controller 110 connecting to dock 104 and retrieving a BIOS image for information handling system 102 from storage 122.

During operation of information handling system 102, dock 104 may be connected or attached to the information handling system via any suitable manner. For example, information handling system 102 and dock 104 may connect through a cable attached to both of USB type-C connectors 116 and 126. In an example, embedded controller 110 may communicate with embedded controller 120 of dock 104 to backup BIOS image 126 in storage 122. In an example, embedded controllers 110 and 120 may utilize a side band communication, such as the configuration channel (CC) line of USB type-C connectors 116 and 126, between information handling system 102 and dock 104 to provide BIOS image 126 to storage 122.

In response to dock 104 being connected to information handling system 102, one or more suitable operations may be performed to authenticate the connection between the information handling system and the dock. In an example, the authentication may be performed in any suitable manner, such as exchanging authentication tokens or signatures, utilizing a private/public key pair, or the like. Based on successful authentication between the systems, embedded controller 110 may unlock and access hidden storage 122. In an example, storage 122 may not be enumerated by information handling system 102 when dock 104 is attached unless the two systems have authenticated each other. In response to hidden storage 122 being unlocked, embedded controller 110 may backup BIOS image 126 within storage 122. In certain examples, embedded controller 110 may perform the backup of BIOS image 126 at different times. For example, embedded controller 110 may back up BIOS image 126 in storage 122 every time BIOS image 126 is updated.

In an example, when information handling system 102 is powered up, embedded controller boot loader 134 may be initialized as part of a first stage of a boot process for the information handling system. In certain examples, embedded controller boot loader 134 may initialize the hardware and load the main application firmware 136 of embedded controller 110. In an example, the main application firmware 136 may be loaded from a storage device like flash memory of embedded controller 110.

In an example, embedded controller 110 may retrieve and validate embedded controller image 136. In an example, the embedded controller image may be firmware for the embedded controller and retrieved from a non-volatile storage of the embedded controller. In certain examples, embedded controller 110 may validate firmware image 136 in any suitable manner. For example, firmware image 136 may be verified via digital signatures, hashing algorithms, cryptographic checks, or the like.

If the validation of firmware image 136 is successful, a validation of a BIOS manifest is performed. In an example, the BIOS manifest may identify firmware, buses, software, and other components to be initialized during BIOS boot operations of SoC 112. In certain examples, the BIOS manifest be validated in any suitable manner. For example, the manifest may be verified via digital signatures, hashing algorithms, cryptographic checks, or the like.

In response to the validation of the BIOS manifest being successful, SoC 112 is released from a reset state. When SoC 112 is released, the SoC may begin boot operations from BIOS image. These boot operations may include, but are not limited to, performing a POST, executing a PEI phase, executing a DXE phase, and executing a BDS phase. During the performance of the boot operations, a determination is made whether SoC 112 has successfully booted. In response SoC, 112 successfully booting to the operating system, information handling system 102 may perform normal operations.

If SoC 112 has not booted, embedded controller boot loader 134 may detect a flash corruption of BIOS image 126 in storage 114 and that backup local copies are broken. In response to flash corruption, information handling system 102 may end up in a NP/NP/NV state. In an example, the flash corruption may refer to BIOS image 126 being corrupted, unavailable, untrusted, or the like. In response to the detection of flash corruption, embedded controller 110 may cause dock 104 to enter a system service mode. In response to dock 104 entering the system service mode, embedded controllers 110 and 120 may enter into a special session by exchanging vendor defined message (VDM) messages over CC lines between type-C connectors 116 and 126. In this special mode, embedded controllers 110 and 120 may negotiate and reconfigure the sideband use (SBU) lines in type-C connectors 116 and 126 as UART lines. In an example, the reconfiguring of the CC lines of type-C connectors 116 and 126 as UART lines may enable dock 104 to operate in a recovery, or system service, mode with faster throughput of the recovery images.

After the CC lines have been reconfigured, embedded controller boot loader 134 and embedded controller firmware 136 may start the recovery of BIOS image 126. In an example, embedded controller 110 may utilize the UART lines to communicate with dock 104 and retrieve BIOS image 126 from hidden storage 122. In response to receiving the image from storage 122, embedded controller 110 may perform one or more suitable operations to validate the received image. In an example, BIOS image 126 received from storage 122 may be validated in any suitable manner, such as exchanging authentication tokens or signatures, utilizing a private/public key pair, or the like.

After validating the received image, embedded controller bootloader 134 and firmware 136 may program or write the back BIOS image 126 into storage 114. In response BIOS image 126 being successfully recovered from storage 122 of dock 104, the UART lines of type-C connectors 116 and 126 are reconfigured back to sideband CC lines. Also, after the recovering of BIOS image 126, embedded controller 110 and dock 104 may exit the system service mode. After information handling system 102 and dock 104 are no longer in the system service mode, the information handling system is reset and a normal boot sequence is performed after the reset.

As described herein, information handling system 102 may be improved by embedded controller 120 by automatically configuring dock 104 as a firmware recovery device after BIOS image 126 is corrupted, unavailable, untrusted, or the like. In an example, embedded controller 110 may reconfigure the CC lines between information handling system 102 and dock 104 as UART lines to enable the dock to operate in a recovery mode with faster throughput of the recovery images.

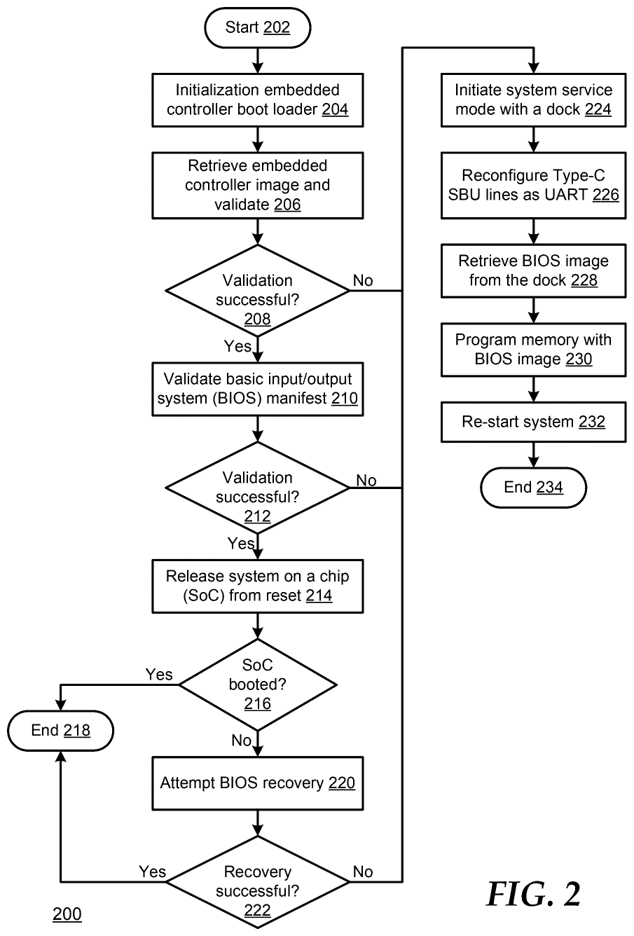

FIG. 2 shows a method 200 for automatically discovering a peripheral device for recovery of an information handling system according to at least one embodiment of the present disclosure, starting at block 202. Not every method step set forth in this flow diagram is always necessary, and certain steps of the methods may be combined, performed simultaneously, in a different order, or perhaps omitted, without varying from the scope of the disclosure. FIG. 2 may be employed in whole, or in part, embedded controller 110 of information handling system 100 in FIG. 1, embedded controller 120 of dock 104 in FIG. 1, or any other type of controller, device, module, processor, or any combination thereof, operable to employ all, or portions of, the method of FIG. 2.

At block 204, an embedded controller boot loader is initialized. In an example, the embedded controller boot loader may be initialized when the embedded controller first powers up as part of a first stage of a boot process. The embedded controller boot loader may initialize the hardware and load the main application firmware of the embedded controller. In certain examples, the main application firmware may be loaded from a storage device like flash memory of the embedded controller.

At block 206, an embedded controller image is retrieved and validated. In an example, the embedded controller image may be firmware for the embedded controller and retrieved from a non-volatile storage of the embedded controller. In certain examples, the embedded controller image may be validated in any suitable manner. For example, the image may be verified via digital signatures, hashing algorithms, cryptographic checks, or the like.

At block 208, a determination is made whether the validation is successful. If the validation fails, the flow continues at block 224. In response to the validation being successful, a BIOS manifest is validated at block 210. In an example, the BIOS manifest may identify firmware, buses, software, and other components to be initialized during BIOS boot operations of the SoC in the information handling system. In certain examples, the BIOS manifest be validated in any suitable manner. For example, the manifest may be verified via digital signatures, hashing algorithms, cryptographic checks, or the like. At block 212, a determination is made whether the validation of the BIOS manifest is successful. If the validation fails, the flow continues at block 224.

In response to the validation being successful, a SoC is released from a reset state at block 214. When the SoC is released, the SoC may begin boot operations. These boot operations may include, but are not limited to, performing a POST, executing a PEI phase, executing a DXE phase, and executing a BDS phase. At block 216, a determination is made whether the SoC has booted. If the SoC has booted, the flow ends at block 218.

If the SoC has not booted, BIOS image recovery is attempted at block 220. In an example, the BIOS image recovery may be performed in any suitable manner. For example, the embedded controller may attempt to retrieve, verify, and load a backup version of the BIOS image. In certain examples, the backup version of the BIOS image may be stored within a storage of the embedded controller, another storage within the information handling system, or the like.

At block 222, a determination is made whether the BIOS image recovery is successful. In an example, the BIOS recovery may be successful if the information handling system may be able to boot to an operating system via execution of the BIOS image recovered from a storage of the information handling system. If the BIOS image recovery is successful, the flow ends at block 218. If the BIOS image recovery is not successful, a system service mode is initiated in a dock at block 224. In an example, the SoC may fail to boot and the BIOS image recovery may fail based on a flash corruption and local backup copies being broken. Based on these image corruptions, the information handling system may end up in a NP/NP/NV state. In an example, the flash corruption may refer to BIOS image being corrupted, unavailable, untrusted, or the like. In response to the dock entering the system service mode, the embedded controllers of both the information handling system and the dock may enter into a special session by exchanging VDM messages over CC lines between type-C connectors.

At block 226, USB type-C SBU lines are reconfigured as UART lines. In an example, the reconfigured UART lines may enable the embedded controller of the information handling system to communicate with the dock in a simpler serial data format as compared to SBU lines of type-C communications.

At block 228, a backup BIOS image is retrieved from the dock. In certain examples, the BIOS image may be retrieved from a hidden storage device of the dock. In response to receiving the backup BIOS image from the dock, the embedded controller of the information handling system may perform one or more suitable operations to validate the received image. In an example, the backup BIOS image received from the dock may be validated in any suitable manner, such as exchanging authentication tokens or signatures, utilizing a private/public key pair, or the like. In an example, after the BIOS image is retrieved from the dock the UART lines are reverted back to SBU lines.

At block 230, the BIOS image is programmed or written to a storage. In certain examples, this backup BIOS image may be written over the broken or corrupted BIOS image already located within the storage of the information handling system. At block 232, the information handling system is restarted and the flow ends at block 234. In response to the information handling system being restarted, SoC may be booted from the backup BIOS image now stored in the storage of the information handling system.

FIG. 3 shows a generalized embodiment of an information handling system 300 according to an embodiment of the present disclosure. Information handling system 300 may be substantially similar to information handling system 102 of FIG. 1. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 364, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332 and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 4394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312 or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300.

Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a system on a chip (SoC) to:
execute boot operations in the information handling system, wherein the boot operations are performed based on a basic input/output system (BIOS) image; and
an embedded controller to communicate with the SoC, the embedded controller to:
monitor the boot operations being executed by the SoC;
in response to a boot failure, enter the information handling system into a service mode; and
during the service mode, retrieve a backup BIOS image from an external device connected to the information handling system.

2. The information handling system of claim 1, wherein prior to the execution of the boot operations, the embedded controller further to:
authenticate a connection between the information handling system and the external device;
in response to the authentication of the connection, unlock a hidden storage of the external device; and
in response to the hidden storage being unlocked, store the backup BIOS image in the hidden storage.

3. The information handling system of claim 2, wherein the backup BIOS image is retrieved from the hidden storage during the service mode.

4. The information handling system of claim 1, wherein after the information handling system is in the service mode, the embedded controller further to: reconfigure sideband use (SBU) lines of a universal serial bus as universal asynchronous receiver transmitter (UART) lines.

5. The information handling system of claim 4, wherein the backup BIOS image is retrieved over the UART lines from the external device.

6. The information handling system of claim 5, wherein after the backup BIOS image is retrieved from the external device, the embedded controller further to: revert the UART lines to the SBU lines of the universal serial bus.

7. The information handling system of claim 1, wherein the embedded controller further to:
store the backup BIOS image in a storage of the information handling system.

8. The information handling system of claim 7, wherein in response to the backup BIOS image being stored in the storage, the SoC further to: execute new boot operations in the information handling system, wherein the new boot operations are performed based on the backup BIOS image.

9. A method comprising:
executing, by a system on a chip (SoC) of an information handling system, boot operations in the information handling system, wherein the boot operations are performed based on a basic input/output system (BIOS) image;
monitoring, by an embedded controller of the information handling system, the boot operations being executed by the SoC;
in response to a boot failure, entering the information handling system into a service mode; and
during the service mode, retrieving, by the embedded controller, a backup BIOS image from an external device connected to the information handling system.

10. The method of claim 9, wherein prior to the executing of the boot operations, the method further comprises:
authenticating a connection between the information handling system and the external device;
in response to the authenticating of the connection, unlocking a hidden storage of the external device; and
in response to the hidden storage being unlocked, storing the backup BIOS image in the hidden storage.

11. The method of claim 10, wherein the backup BIOS image is retrieved from the hidden storage during the service mode.

12. The method of claim 9, wherein after the information handling system is in the service mode, the method further comprising: reconfiguring sideband use (SBU) lines of a universal serial bus as universal asynchronous receiver transmitter (UART) lines.

13. The method of claim 12, wherein the backup BIOS image is retrieved over the UART lines to the external device.

14. The method of claim 13, wherein after the backup BIOS image is retrieved from the external device, the method further comprises: reverting the UART lines to the SBU lines of the universal serial bus.

15. The method of claim 9, further comprising: storing the backup BIOS image in a storage of the information handling system.

16. The method of claim 15, wherein in response to the storing of the backup BIOS image in the storage, the method further comprising: executing, by the SoC, new boot operations in the information handling system, wherein the new boot operations are performed based on the backup BIOS image.

17. A system comprising:
an information handling system including:
a storage configured to store a basic input/output system (BIOS) image;
system on a chip (SoC) to communicate with the storage, the SoC to:
execute boot operations in the information handling system, wherein the boot operations are performed based on the BIOS image; and
an embedded controller to communicate with the storage and with the SoC, the embedded controller to:
monitor the boot operations being executed by the SoC;
in response to a boot failure, enter the information handling system into a service mode; and
during the service mode, retrieve a backup BIOS image from an external device connected to the information handling system; and
an external device to communicate with the embedded controller, the external device includes: a hidden storage to store the backup BIOS image.

18. The system of claim 17, wherein prior to the execution of the boot operations, the embedded controller further to:
authenticate a connection between the information handling system and the external device;
in response to the authentication of the connection, unlock the hidden storage of the external device; and
in response to the hidden storage being unlocked, store the backup BIOS image in the hidden storage.

19. The system of claim 17, wherein after the information handling system is in the service mode, the embedded controller further to: reconfigure sideband use (SBU) lines of a universal serial bus as universal asynchronous receiver transmitter (UART) lines.

20. The system of claim 17, wherein in response to the backup BIOS image being retrieved from the external device, the SoC further to: execute new boot operations in the information handling system, wherein the new boot operations are performed based on the backup BIOS image.
